(19) United States
(12) Patent Application Publication
(10) Pub. No.: US 2011/0001754 A1
(43) Pub. Date: Jan. 6, 2011

(54) DISPLAY APPARATUS AND IMAGE DISPLAYING METHOD

(75) Inventor: Ryota YOKOYAMA, Yokohama-shi (JP)

Correspondence Address: SUGHRUE MION, PLLC, 2100 PENNSYLVANIA AVENUE, N.W., SUITE 800, WASHINGTON, DC, 20037, US

(73) Assignee: RENESAS ELECTRONICS CORPORATION, Kawasaki (JP)

(21) Appl. No.: 12/825,999

(22) Filed: Jun. 29, 2010

(30) Foreign Application Priority Data
Jul. 6, 2009 (JP) 2009-160019

(51) Int. Cl. G09G 5/36; G06F 13/00

(52) U.S. Cl. 345/536; 345/545

(57) ABSTRACT

A display apparatus includes: a display panel; and a frame memory configured to store an image data. An overdrive control section is configured to perform overdrive processing on a first image data read from the frame memory in a current frame period, by using a second image data read from the frame memory in a previous frame period to drive the display panel. A display panel drive control section is configured to drive the display panel based on the overdrive-processed image data.

### INCORPORATION BY REFERENCE

This patent application claims a priority on convention based on Japanese Patent Application No. 2009-160019 filed on Jul. 6, 2009. The disclosure thereof is incorporated herein by reference.

### TECHNICAL FIELD

The present invention relates to a display apparatus having an overdrive processing function.

### BACKGROUND ART

When a difference in a signal level between an image data (of a current frame) which is to be displayed on a display panel (e.g. a liquid crystal panel) and an image data (of a previous frame) displayed on the liquid crystal panel is great, a time for reaching a target level of the current frame becomes long sometimes. For this reason, when a video image with quick changes is inputted, a display panel is driven by the image data of the current frame before reaching a target level in the previous frame, so that a residual image due to the previous frame and a blurred image are displayed on the current frame. As a technique to improve response speed of a liquid crystal panel by preventing occurrence of a residual image and a blurred image, overdrive processing is known. The overdrive is occasionally referred to as OD hereinafter.

In the overdrive processing, image data at identical positions in the current frame and the previous frame are compared, and the image data of the previous frame is corrected by using a correction value in accordance with an amount of change in signal level of the image data. With reference to FIG. 1, the overdrive processing of a general liquid crystal display apparatus will be described.

FIG. 1 is a block diagram showing a general liquid crystal display apparatus having an overdrive processing function. With reference to FIG. 1, the general liquid crystal display apparatus has an image data processing unit 30 and a liquid crystal panel 26 which is driven by display image data 204 from the image data processing unit 30. The image data processing unit 30 has a frame memory 21, an overdrive only memory 22, an overdrive control section 23, an LCD panel drive control section 24, and a frame memory address control section 25.

The frame memory 21 stores an image data 200 which is supplied thereto. At this time, the image data 200 is stored in an area indicated by a write address 211 which is generated by the frame memory address control section 25. Also, an image data 201 is read from the frame memory 21 by the LCD panel drive control section 24, and written in the overdrive only memory 22 and supplied to the overdrive control section 23. At this time, the LCD panel drive control section 24 generates a read address 212 and a write address 213. The image data 201 is read from an area of the frame memory 21 indicated by the read address 212 and is written in an area of the overdrive only memory 22 indicated by the write address 213. In general, the read address 212 and the write address 213 are the same address. For example, the image data 201 read from the top address of the frame memory 21 is written into the top address of the overdrive only memory 22.

The overdrive only memory 22 stores the image data of a previous frame used for overdrive processing. More in detail, the image data 201 read from the frame memory 21 is stored in an area indicated by the write address 213 which is generated by the LCD panel drive control section 24. In a next frame period, an image data 202 is read from an area of the overdrive only memory 22 indicated by the read address 212 which is generated by the LCD panel drive control section 24, and is supplied to the overdrive control section 23. A configuration of the overdrive only memory 22 is the same as that of the frame memory 21, and an address of the frame memory 21 and an address of the overdrive only memory 22 are coincident with each other. For this reason, the image data 201 and 202 are supplied to the overdrive control section 23 from the same address of the frame memory 21 and the overdrive only memory 22, when the read address 212 and the write address 213 are the same.

In a current frame period, the image data 201 of the current frame is read from the frame memory 21 and supplied to the overdrive control section 23, and the image data 202 written in a previous frame, is read from the overdrive only memory 22 and supplied to the overdrive control section 23. After that, the image data 201 read from the frame memory 21 is written into an area of the overdrive only memory 22 corresponding to the write address 213.

The overdrive control section 23 includes a look-up table 27 (hereinafter, to be referred to as an LUT) and an adder 28. The LUT 27 compares the image data 201 from the frame memory 21 and the image data 202 from the overdrive only memory 22, and obtains a correction value. The adder 28 performs correction of addition and subtraction on the image data 202 from the frame memory 21 by using a correction value obtained from the LUT 27, and generates an image data to which overdrive processing has been performed (overdrive-processed data 203).

The LCD panel drive control section 24 reads the image data from the frame memory 21 and the overdrive only memory 22, and outputs an overdrive-processed data 203 to the display panel 26 as a display image data 204 for driving the liquid crystal panel 26. At this time, the LCD panel drive control section 24, to which the overdrive-processed data 203 is supplied, generates a display address 220, and outputs the display image data 204 corresponding to the display address, to the liquid crystal panel 26.

The display image data 204 are supplied to pixels indicated by corresponding display addresses 220, and each pixel is driven in accordance with a signal level (voltage) of the supplied display image data 204.

In general, there are two kinds of methods for displaying a video image, which are a usual video image display and a simplified video image display. First, the usual video image display will be described with reference to FIG. 1.

In a case of the usual video image display, a video image is displayed on the liquid crystal panel 26 by rewriting the image data 201 from the frame memory 21 every time the image data 200 is supplied.

The frame memory 21 stores the image data 200 in an area indicated by the write address 211 which is generated by the frame memory address control section 25. In general, the number of address lines of the frame memory 21 and the overdrive only memory 22a is equal to the number of address lines of the liquid crystal panel 26. The LCD panel drive control section 24 generates the read address 212 for counting address lines from a top address line to a last address line. When the number of address lines in a scan direction of the frame memory 21 and the overdrive only memory 22 is 120, for example, the read address 212 for counting the address lines from the 1^{st} address line to the 120^{th} address line is generated. The image data 201 is read from an area of the frame memory 21 indicated by the read address 212. At this time, the image data 202 is read from an area of the overdrive only memory 22 indicated by the read address 212 which is the same as that for the frame memory 21. The overdrive only memory 22 performs a write operation after the read operation, and stores the image data 201 in the area of the overdrive only memory 22 indicated by the write address 213 which is the same as the read address 212 for the frame memory 21, at the time of the write operation. The overdrive only memory 22 retains the image data of the previous frame by storing the image data 201 from the frame memory 21.

The overdrive control section 23 compares the image data 201 from the frame memory 21 and the image data 202 from the overdrive only memory 22 by using the LUT 27, to obtain a correction value. By adding or subtracting the correction value obtained from the LUT 27 concerning the image data 201, the overdrive-processed data 203 is generated. The LCD panel drive control section 24 outputs the overdrive-processed data 203 to the liquid crystal panel 26 as the display image data 204 in accordance with the display address 220 for counting the address lines from the 1^{st} address line to the 120^{th} address line. Each pixel is driven according to a signal level of the supplied display image data 204.

By performing the above-mentioned operation in units of frames, a video image is displayed on the liquid crystal panel 26.

With reference to FIG. 1, the simplified video image display will be described. The simplified video image display is a method in which a still image is displayed as a video image by controlling the read address 212 and the write address 213 without rewriting image data in the frame memory 21 for each frame. Here, the image displayed on the liquid crystal panel 26 is changed by reading the image data 201 while changing a read address of the frame memory 21. Therefore, it is possible to display the still image as a video image in a simplified manner.

More in detail, input of the image data 200 is stopped and rewriting (updating) of image data to the frame memory 21 is stopped at the time of the simplified video image display. The LCD panel drive control section 24 generates an optional read address 212 and an optional write address 213 (it should be noted that the read address 212 and the write address 213 are the same address). Here, a read start address, a write start address, and a read end address and a write end address are set for reading the image data in a frame period. For example, the LCD panel drive control section 24 sets a read start address between the 1^{st} address line and the 120^{th} address line, and generates the read address 212 for counting the address lines from any address to the 120^{th} address line and counting the address lines from the 1^{st} address line to the address immediately before the address line which is read first. The image data 201 is read from an area of the frame memory 21 indicated by the read address 212. At this time, the image data 202 is read from the overdrive only memory 22, from the same address as the read address 212 of the frame memory 21.

In addition, the LCD panel drive control section 24 sets a write start address between the 1^{st} address line and the 120^{th} address line, and generates the write address 213 for counting the address lines from any address to the 120^{th} address line and counting the address lines from the first address line to the address immediately before the address line which is read first. The overdrive only memory 22 performs a write operation after the read operation. At the time of the write operation, the image data 201 is stored for the write address 213 of the overdrive only memory 22 which is the same as the read address 212.

The overdrive processing and a drive operation by the display image data 204, which are the same as the usual video image display, are not described below. By performing the above-mentioned operation for every frame, a fixed image data on a frame memory can be displayed as a video image in a simplified manner.

A technique related to overdrive processing is described in Patent literature 1, for example.

### Citation List:

[patent literature 1]: JP 2008-11251A

### SUMMARY OF THE INVENTION

In the video image display, a technique of simplified video image display is required in order to increase processing speed and reduce a power consumption amount. In the simplified video image display, a video image is displayed without rewriting image data stored in a frame memory of a liquid crystal display apparatus. Therefore, degradation of the display quality occurs in the simplified video image display compared with a usual video image display, in which image data in a frame memory is rewritten at all times. For this reason, the simplified video image display is required to have an overdrive processing function as in the case of the usual video image display, in order to obtain an image which is as clear as that of the usual video image display.

When the simplified video image display is used in the general liquid crystal display apparatus having the overdrive processing function, not only image data stored in the frame memory 21 but image data stored in the overdrive only memory 22 are fixed since the read address 212 for the frame memory 21 and the write address 213 for the overdrive only memory 22 are the same. That is to say, the image data different from a previous frame displayed on the liquid crystal panel 26 can be stored in the overdrive control section 23. In this case, a wrong correction value is selected by the LUT 27 since overdrive processing is performed by the use of the image data 202 which is different from the previous frame. Therefore, the overdrive processing cannot correctly be performed and a residual image from a previous frame is caused to an image displayed on the liquid crystal panel 26, when the simplified video image display is performed on a general liquid crystal display apparatus.

With reference to FIGS. 2A, 2B and 2C, details of the mechanism of occurrence of the problem that overdrive processing cannot correctly be performed, will be described. As an example, the frame memory 21 and the overdrive only memory 22 are scanned in a scan direction from the 1^{st} address line to the 120^{th} address line, and the number of address lines in each memory is determined in accordance with the number of address lines of the liquid crystal panel 26. In the following description, a period when the (N−1)^{th} frame is displayed, a period when the N^{th} frame is displayed, and a period when the (N+1)^{th} frame is displayed, are referred to as a previous frame period T1, a current frame period T2, and a next frame period T3, respectively.

As shown in FIG. 2A, in the previous frame period T1, the LCD panel drive control section 24 generates the read address 212 and the write address 213 for counting the address lines from the 1^{st} address line to the 120^{th} address line. In accordance with the generated read address 212, image data stored in the frame memory 21 and image data stored in the overdrive only memory 22 are read simultaneously. Here, in a period before the previous frame period T1, the same image data as that of the frame memory 21 is saved in the overdrive only memory 22. In this case, the image data 201 read from the frame memory 21 and the image data 202 read from the overdrive only memory 22 are the same data.

The overdrive control section 23, to which the read image data 201 and image data 202 are supplied, compares the image data 201 and the image data 202 by the LUT 27 in order to obtain a correction value and output the overdrive-processed data 203 corrected by the adder 28. Here, overdrive processing is performed by regarding an image as having no change, since the image data 201 and the image data 202 are the same data. More in detail, the image data 201 is outputted to the LCD panel drive control section 24 without adding or subtracting a correction value. Next, control according to the display address 220 is performed on the overdrive-processed data 203 (the image data 201 in this case) in the LCD panel drive control section 24, in order for the overdrive-processed data 203 to serve as the display image data 204 to drive the liquid crystal panel 26.

On the other hand, the image data 201 read from the frame memory 21 in accordance with the read address 212 is stored in the overdrive only memory 22 in accordance with the write address 213. In the previous frame period T1, the image data is stored in the overdrive only memory 22 in accordance with the write address 213 changed from the 1^{st} address line to the 120^{th} address line in the same way as the read address 212. Therefore, the same image data as that of the frame memory 21 is stored in the overdrive only memory 22.

Next, the time is shifted to the current frame period T2 without updating of the image data in the frame memory 21, as shown in FIG. 2B. In the current frame period T2, the LCD panel drive control section 24 generates the read address 212 and the write address 213 changed as in (1) from the 40^{th} address line to the 120^{th} address line and in (2) from the 1^{st} address line to the 39^{th} address line thereafter. In accordance with the generated read address 212, the image data stored in the frame memory 21 and the image data stored in the overdrive only memory 22 are simultaneously read. Here, the image data stored in the overdrive only memory 22 in the previous frame period T1, and the image data stored in the frame memory 21 in the current frame period T2, are the same data. Therefore, the image data 201 and the image data 202 read from the frame memory 21 and the overdrive only memory 22 respectively in the current frame period T2 are the same data.

The overdrive control section 23, to which the read image data 201 and image data 202 are supplied, compares the image data 201 and the image data 202 in the LUT 27 in order to obtain a correction value and output the overdrive-processed data 203 corrected by the adder 28. Here, overdrive processing is performed by regarding an image as having no change, since the image data 201 and the image data 202 are the same data. More in detail, the image data 201 is outputted to the LCD panel drive control section 24 without adding or subtracting a correction value. Next, control based on the display address 220 is performed on the overdrive-processed data 203 (the image data 201 in this case) in the LCD panel drive control section 24, in order for the overdrive-processed data 203 to serve as the display image data 204 to drive the liquid crystal panel 26.

As mentioned above, a display image in the current frame period T2 is determined to have no change in the overdrive processing in spite of a change from a display image in the previous frame period T1. For this reason, the liquid crystal panel 26 can display a display image in the previous frame period T1 as a residual image in the current frame period T2.

On the other hand, the image data read from the frame memory 21 in accordance with the read address 212, is stored in the overdrive only memory 22 in accordance with the write address 213. In the current frame period T2, the image data is stored in the overdrive only memory 22 in accordance with the write address 213 changed as in (1) from the 40^{th} address line to the 120^{th} address line and in (2) from the 1^{st} address line to the 39^{th} address line in the same way as the read address 212. Therefore, the same image data as that of the frame memory 21 is stored in the overdrive only memory 22.

Next, the time is shifted to the next frame period T3 without updating of the image data in the frame memory 21, as shown in FIG. 2C. In the next frame period T3, the LCD panel drive control section 24 generates the read address 212 and the write address 213 changed as in (1) from the 80^{th} address line to the 120^{th} address line and in (2) from the 1^{st} address line to the 79^{th} address line thereafter. In accordance with the generated read address 212, the image data stored in the frame memory 21 and the image data stored in the overdrive only memory 22 are simultaneously read. Here, the image data stored in overdrive only memory 22 in the current frame period T2, and the image data in the frame memory 21 in the next frame period T3 are the same data. Therefore, the image data 201 and the image data 202 read from the frame memory 21 and the overdrive only memory 22 respectively in the next frame period T3, are the same data.

The overdrive control section 23 receives the image data 201 and image data 202, and compares the image data 201 and the image data 202 by the LUT 27 in order to obtain a correction value and output the overdrive-processed data 203 corrected by the adder 28. Here, the overdrive processing is performed by regarding an image as having no change, since the image data 201 and the image data 202 are the same data. More in detail, the image data 201 is outputted to the LCD panel drive control section 24 without adding or subtracting a correction value. Next, a control based on the display address 220 is performed on the overdrive-processed data 203 (the image data 201 in this case) in the LCD panel drive control section 24, in order for the overdrive-processed data 203 to serve as the display image data 204 to drive the liquid crystal panel 26.

As mentioned above, a display image in the next frame period T3 is judged to have no change in overdrive processing in spite of a change from a display image in the current frame period T2. For this reason, the liquid crystal panel 26 can display a display image of the current frame period T2 as a residual image in the next frame period T3.

On the other hand, the image data read from the frame memory 21 in accordance the read address 212, is stored in the overdrive only memory 22 in accordance with the write address 213. In the next frame period T3, the image data is stored in the overdrive only memory 22 in accordance with the write address 213 changed as in (1) from the 80^{th} address line to the 120^{th} address line and in (2) from the 1^{st} address line to the 79^{th} address line in the same way as the read address 212. Therefore, the same image data as that of the frame memory 21 is stored in the overdrive only memory 22.

As mentioned above, a read address for the frame memory 21, and a read address and a write address for the overdrive only memory 22 are the same in a general liquid crystal display apparatus having an overdrive processing function. When the simplified video image display is performed in such a liquid crystal display apparatus, the image data 201 for displaying a current frame and the image data 202 used for the overdrive processing are the same data. For this reason, the image data is determined to have “no change” in the overdrive processing in spite of a change in an image displayed from the previous frame, and the liquid crystal panel 26 is driven by the image data 202 which is not corrected. As a result, a residual image from a previous frame is displayed on the liquid crystal panel 26.

In an aspect of the present invention, a display apparatus includes: a display panel; and a frame memory configured to store an image data. An overdrive control section is configured to perform overdrive processing on a first image data read from the frame memory in a current frame period, by using a second image data read from the frame memory in a previous frame period to drive the display panel. A display panel drive control section is configured to drive the display panel based on the overdrive-processed image data.

In another aspect of the present invention, an image display method is achieved by storing an image data in a frame memory; by reading a first image data from the frame memory in a current frame period; by performing overdrive processing on the first image data, by using a second image data read from the frame memory in a previous frame period; and by driving a display panel based on the overdrive-processed image data.

According to the present invention, occurrence of a residual image on a display panel can be prevented. Additionally, occurrence of a residual image in the simplified video image display can be prevented. Furthermore, it is possible to perform the overdrive processing in the simplified video image display.

### BRIEF DESCRIPTION OF THE DRAWINGS

The above and other objects, advantages and features of the present invention will be more apparent from the following description of certain embodiments taken in conjunction with the accompanying drawings, in which:

FIG. 1 is a block diagram of a general liquid crystal display apparatus having an overdrive processing function;

FIGS. 2A to 2C are conceptual diagrams showing an example of operation of a simplified video image display in the general liquid crystal display apparatus having an overdrive processing function;

FIG. 3 is a block diagram showing a configuration of a display apparatus according to the present invention;

FIGS. 4A to 4C are conceptual diagrams showing an operation of a simplified video image display of a liquid crystal display apparatus according to a first embodiment of the present invention; and

FIGS. 5A to 5C are conceptual diagrams showing an operation of a simplified video image display of a liquid crystal display apparatus according to a second embodiment of the present invention.

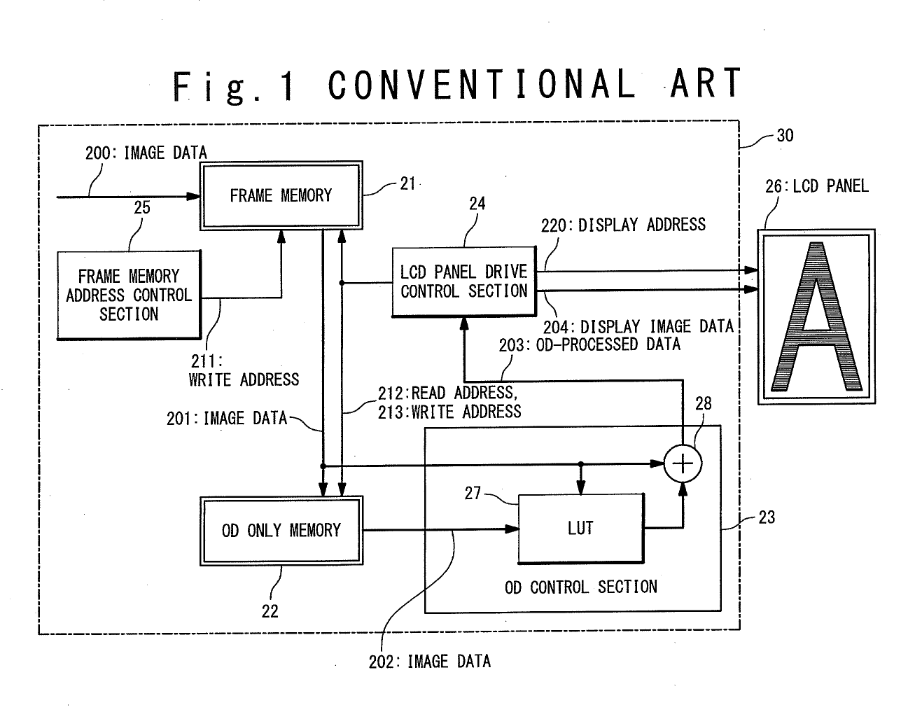

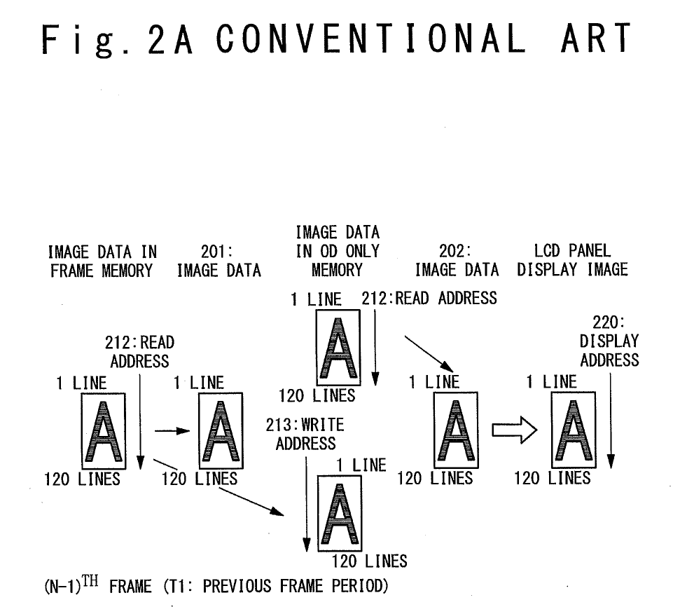

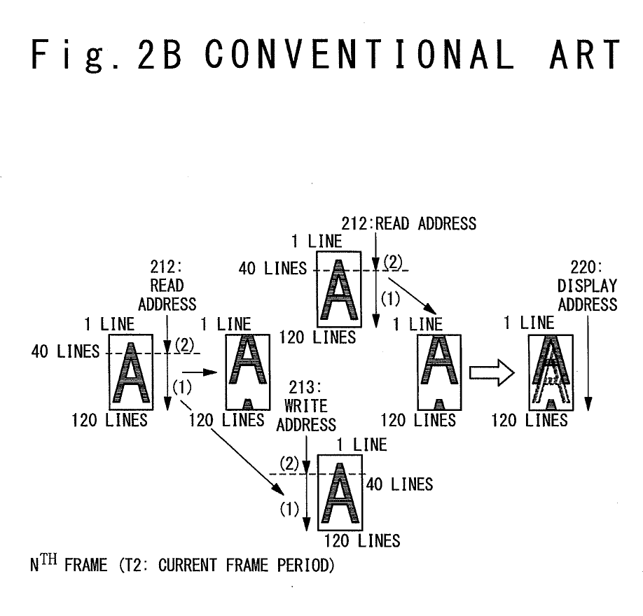

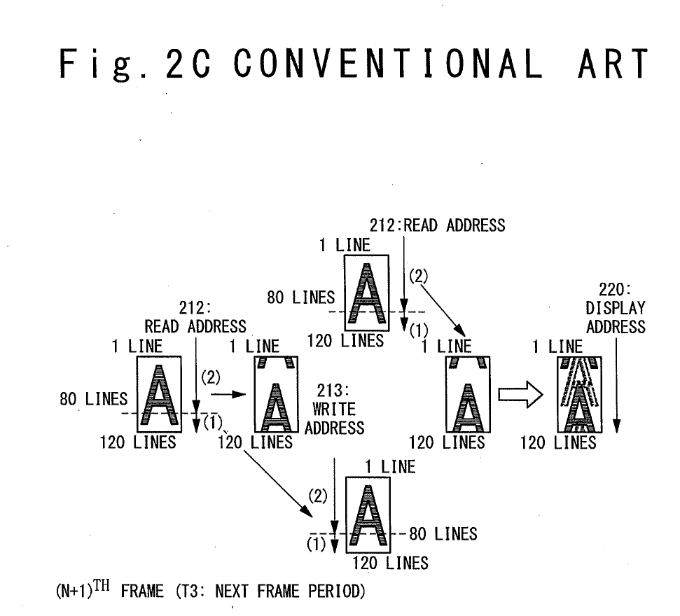

### DESCRIPTION OF EMBODIMENTS

Hereinafter, a liquid crystal display apparatus of the present invention will be described in detail with reference to the attached drawings. In the drawings, same or similar reference numerals are assigned to same or similar components. In the following embodiments, description is given by use of a liquid crystal display apparatus as an example of display apparatus. In the following description, a period during which the (N−1)^{th} frame is displayed, a period during which the N^{th} frame is displayed, and a period during which the (N+1)^{th} frame is displayed are referred to as a previous frame period, a current frame period, and a next frame period, respectively, as in the case of the conventional technique.

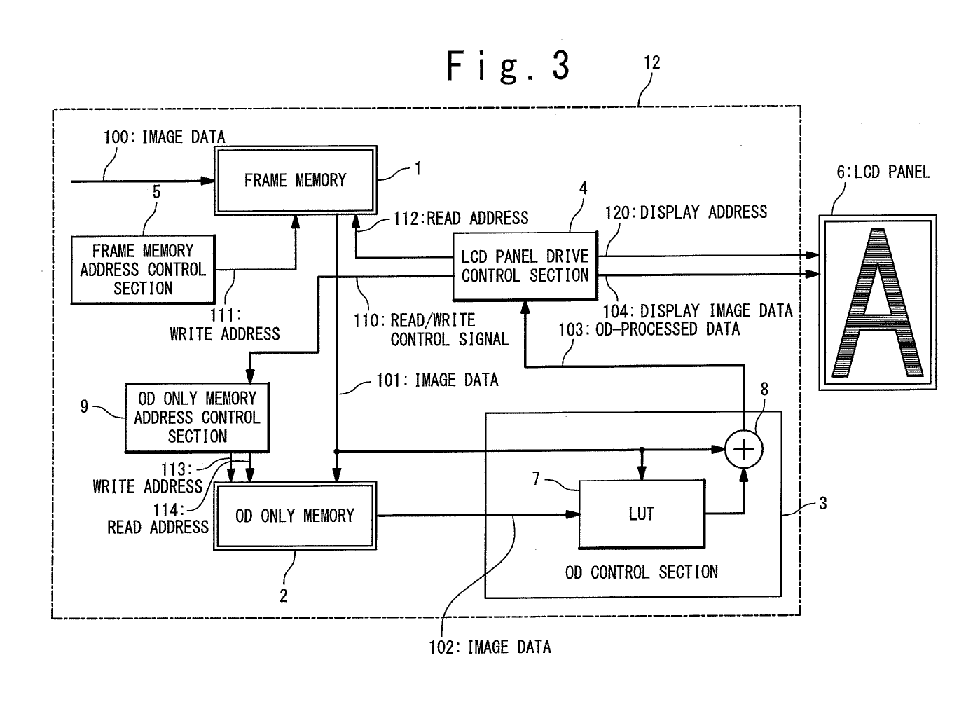

With reference to FIG. 3, a configuration of the liquid crystal display apparatus according to an embodiment of the present invention will be described. FIG. 3 is a block diagram showing the configuration of the display apparatus such as the liquid crystal display apparatus according to the embodiment of the present invention.

The liquid crystal display apparatus according to the present embodiment has an image data processing section 12 and a liquid crystal panel 6 driven with a display image data 104 from the image data processing section 12. The image data processing section 12 is provided with a frame memory 1, an overdrive (OD) only memory 2, an overdrive control section 3, a LCD panel drive control section 4, a frame memory address control section 5, and an overdrive only memory address control section 9.

The frame memory 1 stores an image data 100 which is supplied thereto. At this time, the image data 100 is stored in an area of the frame memory 1 based on write addresses 111 generated by the frame memory address control section 5. An image data 101 is read from the frame memory 1 in accordance with read addresses 112 generated by the LCD panel drive control section 4.

In the overdrive only memory 2, an image data in a previous frame used for overdrive processing is stored. More in detail, the image data 101 read from the frame memory 1 is stored in an area of the overdrive only memory 2 based on the write addresses 113 which are generated by the overdrive only memory address control section 9. Additionally, in the next frame period, an image data 102 is read from the area of the overdrive only memory 2 based on read addresses 114 which are generated by the overdrive only memory address control section 9, and supplied to the overdrive control section 3. The configuration of the overdrive only memory 2 is the same as that of the frame memory 1, and the address to the frame memory 1 and the address to the overdrive only memory 2 are preferably coincident with each other. Furthermore, it is preferable that the number of address lines of the liquid crystal panel 6 is equal to the numbers of address lines of the frame memory 1 or the overdrive only memory 2.

The overdrive only memory address control section 9 generates the write addresses 113 and the read addresses 114 for the overdrive only memory 2 in accordance with a read/write control signal 110 from the LCD panel drive control section 4. More in detail, the overdrive only memory address control section 9 generates the write addresses 113 which include a write start address corresponding to the head address of the display image data 104 for driving the liquid crystal panel 6. Additionally, the same addresses as the write addresses 113 generated in the previous frame period is generated as the read addresses 114 of the current frame period. That is to say, the overdrive only memory address control section 9 generates addresses that correspond to display addresses 120 for driving the liquid crystal panel 6, as the write addresses 113 and the read addresses 114. Consequently, it is possible to use in the previous frame period, the image data, which corresponds to an image displayed on the liquid crystal panel 6, for the overdrive processing.

In the present invention, the overdrive only memory address control section 9 can generate the write addresses 113 and the read addresses 114 for the overdrive only memory 2 independent from the read addresses 112 for the frame memory 1. As a result, the image data 101 read from the frame memory 1 in the previous frame period can be stored in the overdrive only memory 2 (first embodiment). It is also possible to read the image data 101 read from the frame memory 1 in the previous frame period, from the overdrive only memory 2 in the current frame period (second embodiment).

The overdrive control section 3 includes a look-up table 7 (to be referred to as an LUT, hereinafter) and an adder 8. The LUT 7 compares the image data 101 from the frame memory 1 and the image data 102 from the overdrive only memory 2, and obtains a correction value. The adder 8 performs addition and subtraction for correction of the image data 101 from the frame memory 1 by using the correction value obtained by the LUT 7, and generates overdrive processing resultant data (overdrive-processed data 103).

The LCD panel drive control section 4 reads the image data from the frame memory 1 and the overdrive only memory 2, and outputs the overdrive-processed data 103 to the display panel 6 as the display image data 104 for driving the liquid crystal panel 6. More in detail, the LCD panel drive control section 4 generates the read addresses 112 and reads the image data from an area of the frame memory 1 in accordance with the read addresses 112. Additionally, the LCD panel drive control section 4 outputs the read/write control signal 110 to the overdrive only memory address control section 9 and controls write and read of the image data for the overdrive only memory 2. Furthermore, the LCD panel drive control section 4, to which the overdrive-processed data 103 is supplied, generates the display addresses 120, and outputs the display image data 104 corresponding to the display addresses 120, to the liquid crystal panel 6. The LCD panel drive control section 4 generates the display addresses 120 corresponding to the read addresses 112. For example, the read start address of the read addresses 112 corresponds to the head address of the display addresses 120, and the read end address of the read addresses 112 corresponds to the last address of the display addresses 120. The display image data 104 is supplied to pixels indicated by the corresponding display addresses 120, and each pixel is driven in accordance with a signal level (voltage) of the supplied display image data 104.

The read/write control signal 110 outputted from the LCD panel drive control section 4 includes a data for controlling timings at which the write addresses 113 and the read addresses 114 are generated. Additionally, the read/write control signal 110 may include a data for designating the write addresses 113 and the read addresses 114. For example, the LCD panel drive control section 4 designates the read start address, the read end address, the write start address, and the write end address which are previously set (first embodiment). In this case, the overdrive only memory address control section 9 generates the write addresses 113 and the read addresses 114 from the top address to the last address in accordance with the read/write control signal 110. Alternatively, as another example, the read/write control signal 110 includes a data to use the read addresses 112 generated in the current frame period as the write addresses 113 of the current frame period, and the read addresses 112 generated in the previous frame period as the read addresses 114 generated in the current frame period (second embodiment). In this case, the overdrive only memory address control section 9 generates the same write addresses 113 as the read addresses 112 generated in the current frame period and generates the same read addresses 114 as the read addresses 112 generated in the previous frame period, in accordance with the read/write control signal 110.

With the above configuration, the liquid crystal display apparatus of the present invention displays the image data 100 supplied to the frame memory 1 on the liquid crystal panel 6 after performing the overdrive processing to the image data 100.

With reference to FIG. 3, an operation for a video image display by a liquid crystal display apparatus according to the first embodiment of the present invention will be described. The overdrive only memory address control section 9 in the first embodiment generates the write addresses 113 and the read addresses 114 in accordance with the read/write control signal 110 to indicate addresses from the top address (top address line) to the last address (last address line) of the overdrive only memory 2.

In a case of a usual video image display, new image data 100 is supplied for each frame to update a frame memory 1. Additionally, the read addresses 112 for the frame memory 1 are fixed. For example, the top address of the frame memory 1 serves as the read start address, and the last address serves as the read end address. In the case of a simplified video image display, on the other hand, new image data 100 is not supplied even when frames are changed, and the same image data is retained without rewriting the image data in the frame memory 1. Additionally, the read addresses 112 for the frame memory 1 is freely set.

The operation for the video image display from extraction of image data from the frame memory 1 to the display of the image data on the liquid crystal panel 6 will be described below. The same operation for the video image display is applied to both of the usual video image display and the simplified video image display, excluding the difference in the setting of the read addresses 112 as mentioned above.

The frame memory 1 stores the image data 100 in an area indicated based on the write addresses 111 generated by the frame memory address control section 5. The LCD panel drive control section 4 generates any read addresses 112 and reads the image data 101 from the area of the frame memory 1 indicated by the read addresses 112. Here, the read start address and the read end address for reading image data are set at least. When the numbers of address lines of the frame memory 1 and the overdrive only memory 2 in the scan direction are 120, the LCD panel drive control section 4 sets the read start address at which the read is started between the 1^{st} address line and the 120^{th} address line, and generates the read addresses 112 for counting the address lines from any address line to the 120^{th} address line and counting the address lines from the 1^{st} address line to the address immediately before the address line which has been read first. It should be noted that in the case of the usual video image display, it is preferable that the read addresses 112 are generated to count the address lines from the top address line (1^{st} address line) to the last address line (120^{th} address line).

The LCD panel drive control section 4 outputs the write/read control signal 110 simultaneously with the generation of the read addresses 112. The overdrive only memory address control section 9 generates the read addresses 114 and the write addresses 113 for counting the address lines from the top address line (1^{st} address line) to the last address line (120^{th} address line) of the overdrive only memory, in accordance with the write/read control signal 110. Consequently, the image data 102 is read from an area of the overdrive only memory 2 indicated by the read addresses 114.

In the overdrive only memory 2, in which the write operation is performed after the read operation, the image data 101 is stored in an area of the overdrive only memory 2 indicated by the write addresses 113 at the time of the write operation. The overdrive only memory 2 retains the image data in the previous frame by storing the image data 101 in the frame memory 1.

The overdrive control section 3 compares the image data 101 in the frame memory 1 and the image data 102 in the overdrive only memory 2 by use of the LUT 7, in order to obtain a correction value in accordance with the difference. By adding or subtracting the correction value obtained from the LUT 7 for the image data 101, the overdrive-processed data 103 is generated. The LCD panel drive control section 4 generates the display addresses 120 for counting the address lines from the top address line (1^{st} address line) to the last address line (120^{th} address line) of the liquid crystal panel 6, and outputs the overdrive-processed data 103 to the liquid crystal panel 6 as the display image data 104. Each pixel is driven in accordance with a signal level of the supplied display image data 104.

The read addresses 112 are for the image data 101 as a source of the display image data 104 for driving the liquid crystal panel 6, correspond to the display addresses 120 (from the top address to the last address in the liquid crystal panel 6). For example, the read start address for the frame memory 1 corresponds to the top address of the liquid crystal panel 6 and the read end address corresponds to the last address of the liquid crystal panel 6. In the present embodiment, the image data 101 read from any read start address is written into the overdrive only memory 2 in order starting from the top address. For this reason, the overdrive only memory 2 stores not the image data 100 stored in the frame memory 1 in the previous frame period but the image data 101 read from the frame memory 1 in the previous frame period, namely, the image data 101 which corresponds to an image displayed on the liquid crystal panel 6 in the previous frame period.

By performing the above operation for each frame, the usual video image display or the simplified video image display is performed on the liquid crystal panel 6.

In the liquid crystal display apparatus of the first embodiment, the read addresses 112 for the frame memory 1 and the write addresses 113 for the overdrive only memory 2 are set independently. Therefore, the image data that corresponds to an image displayed on the liquid crystal panel 6 in the previous frame period, can be stored in the overdrive only memory 2. As a result, the overdrive control section 3 can perform overdrive processing on the image data 101 read from the frame memory 1 in the current frame period by using the image data 101 which is a source of an image having displayed in the previous frame period. That is to say, the present invention makes it possible to perform the overdrive processing in accordance with difference from an image displayed in the previous frame period, and prevent occurrence of a residual image, which has been a problem in the conventional liquid crystal display apparatus.

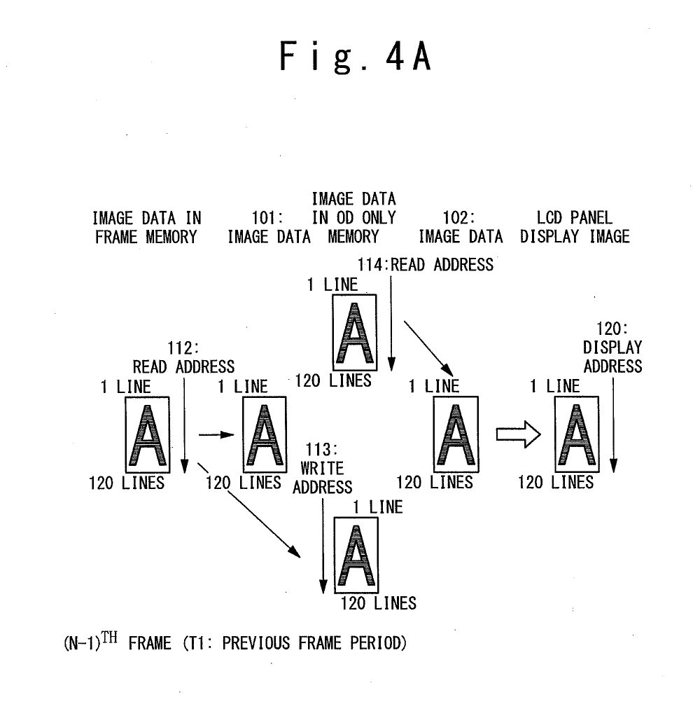

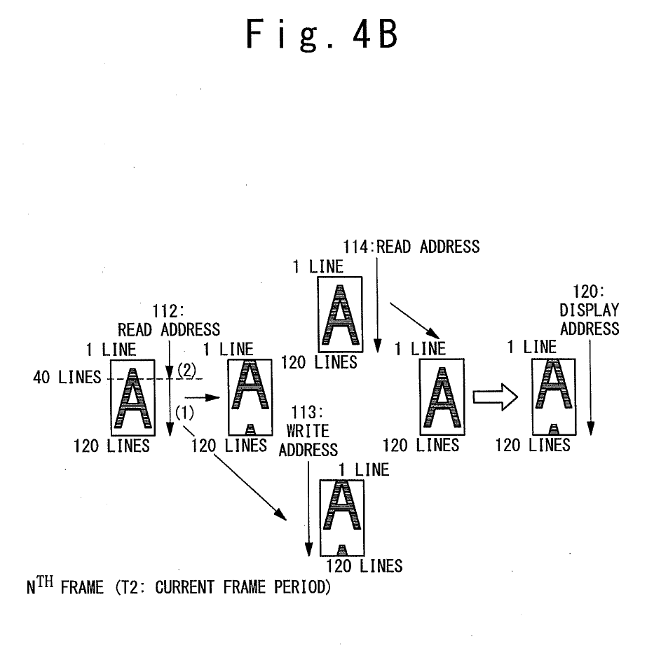

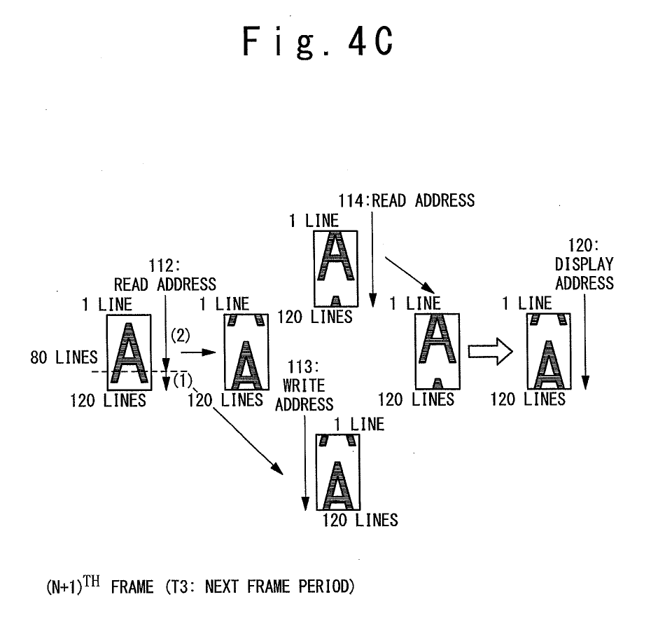

With reference to FIGS. 4A to 4C, a specific example of the operation of the simplified video image display in the first embodiment and details of the mechanism of the effect will be described. FIG. 4A is a conceptual diagram showing the operation of the simplified video image display by the liquid crystal display apparatus according to the first embodiment of the present invention. As an example, the number of address lines of the frame memory 1 or the overdrive only memory 2 in the scan direction is 120 from the 1^{st} address line to the 120^{th} address line, and the number of address lines of each memory is a value in accordance with the number of address lines of the liquid crystal panel 6. In the following description, a period when the (N−1)^{th} frame is displayed, a period when the N^{th} frame is displayed, and a period when the (N+1)^{th} frame is displayed, are referred to as a previous frame period T1, a current frame period T2, and a next frame period T3, respectively.

In the previous frame period T1, the LCD panel drive control section 4 generates the read addresses 112 for counting the address lines from the 1^{st} address line to the 120^{th} address line, and generates the read/write address control signal 110. The overdrive only memory address control section 9 generates the write addresses 113 and the read addresses 114 for counting the address lines from the 1^{st} address line to the 120^{th} address line in accordance with the read/write address control signal 110. The image data 101 is read from the frame memory 1 in accordance with the generated read addresses 112, and the image data 102 is read from the overdrive only memory 2 in accordance with the read addresses 114. Here, the same image data as that of the frame memory 1 is stored in the overdrive only memory 2 in a period before the previous frame period T1. In this case, the read image data 101 and image data 102 are the same data.

The overdrive control section 3, to which the image data 101 and the image data 102 are supplied, compares the image data 101 and the image data 102 by the LUT 7 in order to obtain the correction value, and outputs the overdrive-processed data processing 3 corrected by the adder 8. Here, the overdrive processing is performed by regarding an image as having no change, since the image data 101 and the image data 102 are the same data. More in detail, the image data 101 is outputted to the LCD panel drive control section 4 without adding and subtracting the correction value. Next, the control to subject the overdrive-processed data 103 (the image data 101 in this case) to the display addresses 120 is performed in the LCD panel drive control section 4, in order for the overdrive-processed data 103 to serve as the display image data 104 to drive the liquid crystal panel 6. Although the overdrive-processed data not subjected to the correction is displayed on the liquid crystal panel in the previous frame period T1, image quality is not affected since there is no change in an image displayed on the liquid crystal panel 6 from the previous frame.

On the other hand, the image data read from the frame memory 1 in accordance with the read addresses 112 is stored in the overdrive only memory 2 in accordance with the write addresses 113. In the previous frame period T1, the image data is stored in the overdrive only memory 2 in accordance with the write addresses 113 for counting the address lines from the 1^{st} address line to the 120^{th} address line in the same way as the display addresses 120. Here, the image data stored from the 1^{st} address line to the 120^{th} address line in the frame memory 1 is stored from the 1^{st} address line to the 120^{th} address line in the overdrive only memory 2. Consequently, the image data 101 read in the previous frame period T1 is stored in the addresses of the overdrive only memory 2 that correspond to the display addresses 120.

Next, the state is shifted to the current frame period T2 without updating of the image data in the frame memory 1, as shown in FIG. 4B. In the current frame period T2, the LCD panel drive control section 4 generates the read addresses 112 for (1) counting the address lines from the 40^{th} address line to the 120^{th} address line and then (2) counting the address lines from the 1^{st} address line to the 39^{th} address line, and generates the read/write address control signal 110. The overdrive only memory address control section 9 generates the write addresses 113 and the read addresses 114 for counting the address lines from the 1^{st} address line to the 120^{th} address line in accordance with the read/write address control signal 110. The image data 101 is read from the frame memory 1 in accordance with the generated read addresses 112, and the image data 102 is read from the overdrive only memory 2 in accordance with the read addresses 114.

The overdrive control section 3, to which the image data 101 and the image data 102 are supplied, compares the image data 101 and the image data 102 by the LUT 7 in order to obtain the correction value, and outputs the overdrive-processed data 103 corrected by the adder 8. In the overdrive only memory 2, the image data corresponding to an image displayed on the liquid crystal panel 6 is stored in the previous frame period T1. In the current frame period T2, the image data stored in the frame memory 1 and the image data stored in the overdrive only memory 2 are the same. However, the image data 101 and the image data 102 are different data since the read addresses 112 for the frame memory 1 and the read addresses 114 for the overdrive only memory 2 are different. Additionally, the image data 102 read from the overdrive only memory 2 is the same data as the image data 101 corresponding to the image displayed on the liquid crystal panel 6 in the previous frame period T1 since the read addresses 114 correspond to the display addresses 120. For this reason, the difference between the image data 101 and the image data 102 for the overdrive processing is a value that corresponds to the difference between the current frame image displayed on the liquid crystal panel 6 and the previous frame image which has already been displayed. Therefore, the overdrive control section 3 can correct the image data 101 of the current frame by using the correction value in accordance with difference from the display image of the liquid crystal panel 6 in the previous frame period T1.

The control to subject the overdrive-processed data 103 to the display address 120 is performed in the LCD panel drive control section 4, in order for the overdrive-processed data 103 to be stored as the display image data 104 to drive the liquid crystal panel 6. At this time, a residual image from a previous frame image is not caused on an image displayed on the liquid crystal panel 6 since the correction according to the difference from the previous frame image is performed in the overdrive processing.

On the other hand, the image data read from the frame memory 1 in accordance with the read addresses 112 is stored in the overdrive only memory 2 in accordance with the write addresses 113. In the current frame period T2, the image data is stored in the overdrive only memory 2 in accordance with the write addresses 113 for counting the address lines from the 1^{st} address line to the 120^{th} address line in the same way as the display addresses 120. For this reason, the same image data as the image data 101 corresponding to the display image data 104 which is to drive the liquid crystal panel 6 in the current frame period T2, is stored in the overdrive only memory 2. Here, the image data from the 40^{th} address line to the 120^{th} address line in the frame memory 1 is stored from the 1^{st} address line to the 80^{th} address line in the overdrive only memory 2, and the image data from the 1^{st} address line to the 39^{th} address line in the frame memory 1 is stored from the 81^{st} address line to the 120^{th} address line in the overdrive only memory 2. As a result, the image data 101 read in the current frame period is stored in the addresses of the overdrive only memory 2 which correspond to the display addresses 120.

The state is shifted to the next frame period T3 without updating of the image data in the frame memory 1, as shown in FIG. 4C. In the next frame period T3, the LCD panel drive control section 4 generates the read addresses 112 for (1) counting the address lines from the 80^{th} address line to the 120^{th} address line and then (2) counting the address lines from the 1^{st} address line to the 79^{th} address line, and generates the read/write address control signal 110. The overdrive only memory address control section 9 generates the write addresses 113 and the read addresses 114 for counting the address lines from the 1^{st} address line to the 120^{th} address line in accordance with the read/write address control signal 110. The image data 101 is read from the frame memory 1 in accordance with the generated read addresses 112, and the image data 102 is read from the overdrive only memory 2 in accordance with the read addresses 114.

The overdrive control section 3, to which the read image data 101 and image data 102 are supplied, compares the image data 101 and the image data 102 by the LUT 7 in order to obtain the correction value, and outputs the overdrive-processed data 103 corrected by the adder 8. In the overdrive only memory 2, the image data corresponding to the image displayed on the liquid crystal panel 6 is stored in the current frame period T2. Since the read addresses 114 correspond to the display addresses 120, the image data 102 read from the overdrive only memory 2 is the same data as the image data 101 corresponding to the image displayed on the liquid crystal panel 6 in the current frame period T2. For this reason, the difference between the image data 101 and the image data 102 for overdrive processing is a value corresponding to the difference between the next frame image displayed on the liquid crystal panel 6 and the current frame image which has already been displayed. Therefore, the overdrive control section 3 can correct the image data 101 in the next frame by using the correction value in accordance with the difference from the display image on the liquid crystal panel 6 in the current frame period T2.

The control to subject the overdrive-processed data 103 to the display addresses 120 is performed by the LCD panel drive control section 4, in order for the overdrive-processed data 103 to serve as the display image data 104 to drive the liquid crystal panel 6. At this time, a residual image due to a current frame image is not caused on an image displayed on the liquid crystal panel 6 in the next frame period T3 since the correction in accordance with the difference from the current frame image is performed in the overdrive processing.

On the other hand, the image data read from the frame memory 1 in accordance with the read addresses 112 is stored in the overdrive only memory 2 in accordance with the write addresses 113. In the next frame period T3, the image data is stored in the overdrive only memory 2 in accordance with the write addresses 113 for counting the address lines from the 1^{st} address line to the 120^{th} address line in the same way as the read addresses 112. For this reason, the same image data as the image data 101 corresponding to the display image data 104 which is to drive the liquid crystal panel 6 in the next frame period T3, is stored in the overdrive only memory 2. Here, the image data from the 80^{th} address line to the 120^{th} address line in the frame memory 1 is stored from the 1^{st} address line to the 40^{th} address line in the overdrive only memory 2, and the image data from the 1^{st} address line to the 79^{th} address line of the frame memory 1 is stored from the 41^{st} address line to the 120^{th} address line in the overdrive only memory 2. Consequently, the image data 101 read in the current frame period is stored in the addresses of the overdrive only memory 2 corresponding to the display addresses 120.

The simplified video image display including the overdrive processing is performed in the same way for subsequent frame periods as well.

In the liquid crystal display apparatus of the first embodiment, the write and read of the image data for the overdrive only memory 2 is performed with the use of the write addresses 113 and the read addresses 114 which correspond to the display addresses 120 irrespective of the read addresses 112 for the frame memory. For this reason, it is possible to store the same image data as the image displayed on the liquid crystal panel 6 in the previous frame period in the overdrive only memory 2 and use the data for the overdrive processing. That is to say, the image data 101 read from the frame memory 1 in the previous frame period can be used for the overdrive processing in the current frame period. Consequently, it is possible to perform the overdrive processing by obtaining the difference between image data of the current frame and image data of the previous frame (corresponding to an image displayed on the liquid crystal panel 6), and prevent occurrence of a residual image due to a previous frame.

With reference to FIG. 3, the overdrive only memory address control section 9 according to the second embodiment generates the same addresses as the read addresses 112 in the current frame period as the write addresses 113 in the current frame period, and generates the same addresses as the read addresses 112 (write addresses 113) in the previous frame period as the read addresses 114 in the current frame period. The other operation is the same as in the first embodiment, and only different operation will be described.

A LCD panel drive control section 4 outputs a write/read control signal 110 simultaneously with generation of the read addresses 112. The overdrive only memory address control section 9 generates the same addresses as the read addresses 112 in the current frame period as the write addresses 113 in the current frame period, and generates the same addresses as the read addresses 112 (write addresses 113) in the previous frame period as the read addresses 114 in the current frame period, in accordance with the write/read control signal 110. As a result, the image data 102 is read from an area of the overdrive only memory 2 indicated by the read addresses 114. Since the read addresses 114 are the same as the read addresses 112 in the previous frame period, the image data 102 is the same data as image data 101 read from the frame memory 1 in the previous frame period.

In the overdrive only memory 2, in which the write operation is performed after the read operation, the image data 101 is stored in an area of the overdrive only memory 2 indicated by the write addresses 113 at the time of write operation. The overdrive only memory 2 stores the image data in the frame memory 1 by storing the image data 101 in the frame memory 1.

In the liquid crystal display apparatus according to the second embodiment, in which the same image data as that of the frame memory 1 is stored, the image data 102 read from the overdrive only memory 2 in the current frame period is the same data as the image data 101 corresponding to the image displayed on the liquid crystal panel 6 in the previous frame period since the read addresses 114 for the overdrive only memory 2 is the same as the read addresses 112 for the frame memory 1 in the previous frame period. For this reason, the overdrive control section 3 can perform the overdrive processing on the image data 101 read from the frame memory 1 in the current frame period, by using the image data 101 which is a source of the image displayed in the previous frame period. That is to say, the present invention makes it possible to perform the overdrive processing in accordance with difference from the image displayed in the previous frame period and prevent occurrence of a residual image, which is a problem in the conventional liquid crystal display apparatus.

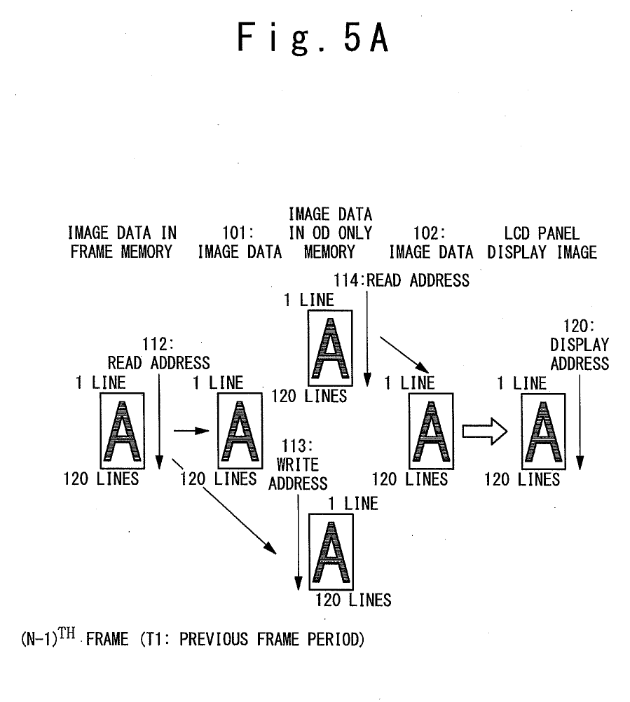

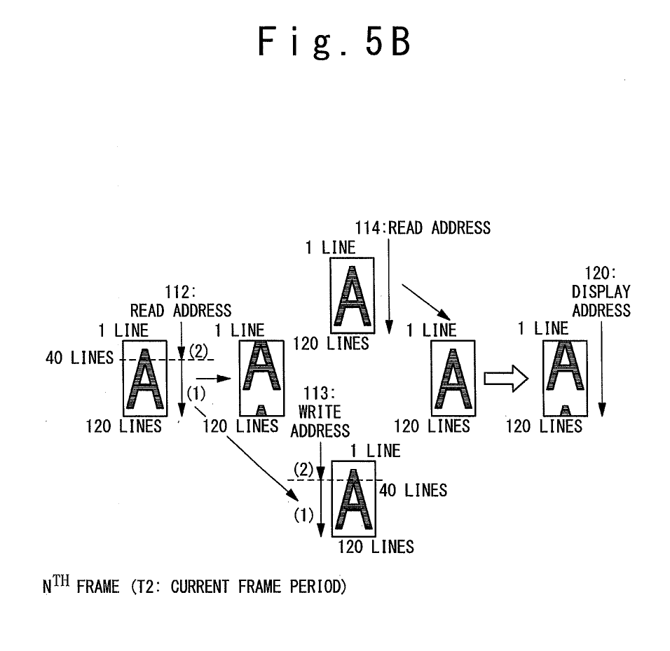

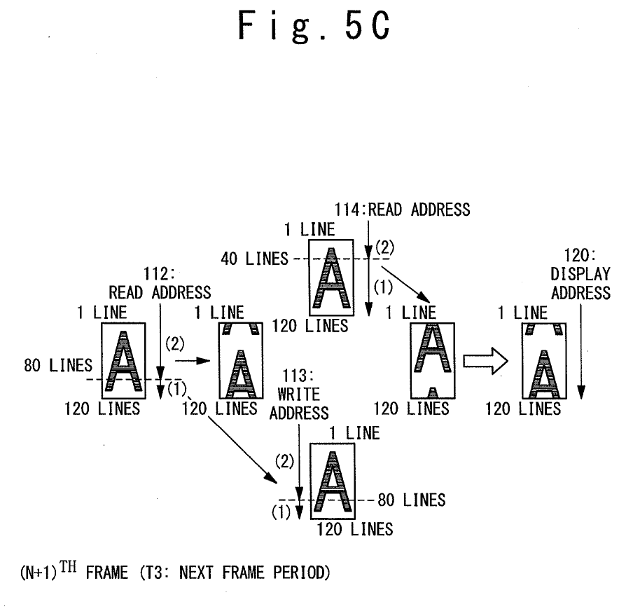

With reference to FIGS. 5A to 5C, a specific example of operation of the simplified video image display in the second embodiment and details of the mechanism of the effect are described. FIGS. 5A to 5C are conceptual diagrams showing the operation of the liquid crystal display apparatus according to the second embodiment of the present invention in the simplified video image display. As an example, the number of address lines of the frame memory 1 and the overdrive only memory 2 in the scan direction is 120 and the address lines are from the 1^{st} address line to the 120^{th} address line, and the number of address lines of each memory is a value determined in accordance with the number of address lines of the liquid crystal panel 6. In the following description, a period when the (N−1)^{th} frame is displayed, a period when the N^{th} frame is displayed, and a period when the (N+1)^{th} frame is displayed, are referred to as a previous frame period T1, a current frame period T2, and a next frame period T3, respectively.

In the previous frame period T1, as shown in FIG. 5A, the LCD panel drive control section 4 generates the read addresses 112 for counting the address lines from the 1^{st} address line to the 120^{th} address line and generates the read/write address control signal 110. The overdrive only memory address control section 9 generates the write addresses 113 and the read addresses 114 for counting the address lines from the 1^{st} address line to the 120^{th} address line in accordance with the read/write address control signal 110. The image data 101 is read from the frame memory 1 in accordance with the generated read addresses 112, and the image data 102 is read from the overdrive only memory 2 in accordance with the read addresses 114. Here, the same image data as that of the frame memory 1 is saved in the overdrive only memory 2 in a period before the previous frame period T1. In this case, the read image data 101 and image data 102 are the same data.

The overdrive control section 3, to which the read image data 101 and image data 102 are supplied, compares the image data 101 and the image data 102 by the LUT 7 in order to obtain the correction value and outputs the overdrive-processed data 103 corrected by the adder 8. Here, the overdrive processing is performed by regarding the image as having no change since the image data 101 and the image data 102 are the same data. More in detail, the image data 101 is outputted to the LCD panel drive control section 4 without adding or subtracting the correction value. Next, the control to subject the overdrive-processed data 103 (the image data 101 in this case) to the display addresses 120 is performed in the LCD panel drive control section 4, in order for the overdrive-processed data 103 to serve as the display image data 104 to drive the liquid crystal panel 6. Although the overdrive-processed data subjected to no correction is displayed on the liquid crystal panel in the previous frame period T1, image quality is not affected since there is no change in the image displayed on the liquid crystal panel 6 from the previous frame.

On the other hand, the image data read form the frame memory 1 in accordance with the read addresses 112 is stored in the overdrive only memory 2 in accordance with the write addresses 113. In the present embodiment, the image data is stored in the overdrive only memory 2 in accordance with the write addresses 113 for counting the address lines from the 1^{st} address line to the 120^{th} address line in the same way as the read addresses 112 in the previous frame period T1. Here, the image data from the 1^{st} address line to the 120^{th} address line in the frame memory 1 is stored from the 1st address line to the 120^{th} address line in the overdrive only memory 2. As a result, the image data in the frame memory 1 in the previous frame period T1, is stored in the overdrive only memory 2.

Next, the state is shifted to the current frame period T2 without updating of the image data in the frame memory 1. In the current frame period T2, the LCD panel drive control section 4 generates the read addresses 112 for (1) counting the address lines from the 40^{th} address line to the 120^{th} address line and then (2) counting the address lines from the 1^{st} address line to the 39^{th} address line, and generates the read/write address control signal 110. The overdrive only memory address control section 9 generates the write addresses 113 for (1) counting the address lines from the 40^{th} address line to the 120^{th} address line and then (2) counting the address lines from the 1^{st} address line to the 39^{th} address line, and the read addresses 114 for counting the address lines from the 1^{st} address line to the 120^{th} address line, in accordance with the read/write address control signal 110. The image data 101 is read from the frame memory 1 in accordance with the generated read addresses 112, and the image data 102 is read from the overdrive only memory 2 in accordance with the read addresses 114.

The overdrive control section 3, to which the image data 101 and the image data 102 are supplied, compares the image data 101 and the image data 102 by the LUT 7 in order to obtain the correction value and outputs the overdrive-processed data 103 corrected by the adder 8. The image data stored in the frame memory 1 and the image data stored in the overdrive only memory 2 are the same. However, the image data 101 and the image data 102 are different data since the read addresses 112 for the frame memory 1 and the read addresses 114 for the overdrive only memory 2 are different. Additionally, the image data 102 read from the overdrive only memory 2 is the same as the image data 101 corresponding to the image displayed on the liquid crystal panel 6 in the previous frame period T1 since the read addresses 114 is the same as the read addresses 112 in the previous frame period T1. For this reason, the difference between the image data 101 and the image data 102 for the overdrive processing is a value corresponding to the difference between the current frame image displayed on the liquid crystal panel 6 and the previous frame image which has already been displayed. Therefore, the overdrive control section 3 can correct the image data 101 of the current frame by using the correction value in accordance with the difference from the display image of the liquid crystal panel 6 of the previous frame period T1.

The control to subject the overdrive-processed data 103 to the display addresses 120 is performed in the LCD panel drive control section 4, in order for the overdrive-processed data 103 to serve as the display image data 104 to drive the liquid crystal panel 6. At this time, a residual image due to the previous frame image is not caused to the image displayed on the liquid crystal panel 6 since the correction in accordance with the difference from the previous frame is performed in the overdrive processing.

On the other hand, the image data read from the frame memory 1 in accordance with the read addresses 112, is stored in the overdrive only memory 2 in accordance with the write addresses 113. In the present embodiment, the image data is stored in the overdrive only memory 2 in accordance with the write addresses 113 for (1) counting the address lines from the 40^{th} address line to the 120^{th} address line and then (2) counting the address lines from the 1^{st} address line to the 39^{th} address line, in the same way as the read addresses 112 in the current frame period T2. Therefore, the same image data as that of the frame memory 1 in the current frame period T2, is stored in the overdrive only memory 2. Here, the image data from the 40^{th} address line to the 120^{th} address line in the frame memory 1 is stored from the 40^{th} address line to the 120^{th} address line in the overdrive only memory 2, and the image data from the 1^{st} address line to the 39^{th} address line in the frame memory 1 is stored from the 1^{st} address line to the 39^{th} address line in the overdrive only memory 2.

Next, the state is shifted to the next frame period T3 without updating of image data in the frame memory 1, as shown in FIG. 5C. In the next frame period T3, the LCD panel drive control section 4 generates the read addresses 112 for (1) counting the address lines from the 80^{th} address line to the 120^{th} address line and then (2) counting the address lines from the 1^{st} address line to the 79^{th} address line, and generates the read/write address control signal 110. The overdrive only memory address control section 9 generates the write addresses 113 for (1) counting the address lines from the 80^{th} address line to the 120^{th} address line and then (2) counting the address lines from the 1^{st} address line to the 79^{th} address line, and the read addresses 114 for (1) counting the address lines from the 40^{th} address line to the 120^{th} address line and then (2) counting the address lines from the 1^{st} address line to the 39^{th} address line. The image data 101 is read from the frame memory 1 in accordance with the generated read addresses 112, and the image data 102 is read from the overdrive only memory 2 in accordance with the read addresses 114.

The overdrive control section 3, to which the read image data 101 and image data 102 are supplied, compares the image data 101 and the image data 102 by the LUT 7 in order to obtain the correction value and outputs the overdrive-processed data 103 corrected by the adder 8. The image data stored in the frame memory 1 and the image data stored in the overdrive only memory 2 are the same. However, the image data 101 and the image data 102 are different data since the read addresses 112 for the frame memory 1 and the read addresses 114 for the overdrive only memory 2 are different. Additionally, the image data 102 read from the overdrive only memory 2 is the same as the image data 101 corresponding to the image displayed on the liquid crystal panel 6 in the current frame period T2, since the read addresses 114 is the same as the read addresses 112 of the current frame period T2. For this reason, the difference between the image data 101 and the image data 102 for the overdrive processing is a value corresponding to the difference between the next frame image displayed on the liquid crystal panel 6 and the current frame image which has already been displayed. Therefore, the overdrive control section 3 can correct the image data 101 of the next frame by using the correction value in accordance with the difference from the display image of the liquid crystal panel 6 of the current frame period T2.

The control to subject the overdrive-processed data 103 to the display addresses 120 is performed in the LCD panel drive control section 4, in order for the overdrive-processed data 103 to serve as the display image data 104 to drive the liquid crystal panel 6. At this time, a residual image due to the current frame image is not caused to the image displayed on the liquid crystal panel 6 in the next frame period T3 since the correction in accordance with the difference from the current frame image is performed in the overdrive processing.

On the other hand, the image data read from the frame memory 1 in accordance with the read addresses 112, is stored in the overdrive only memory 2 in accordance with the write addresses 113. In the next frame period T3, the image data is stored in the overdrive only memory 2 in accordance with the write addresses 113 for (1) counting the address lines from the 40^{th} address line to the 120^{th} address line and then (2) counting the address lines from the 1^{st} address line to the 39^{th} address line in the same way as the read addresses 112 in the current frame period T2. For this reason, the same image data as that of the frame memory 1 in the current frame period T2 is stored in the overdrive only memory 2. Here, the image data from the 40^{th} address line to the 120^{th} address line in the frame memory 1 is stored from the 40^{th} address line to the 120^{th} address line in the overdrive only memory 2, and the image data from the 1^{st} address line to the 39^{th} address line in the frame memory 1 is stored from the 1^{st} address line to the 39^{th} address line in the overdrive only memory 2. In the present embodiment, the image data is stored in the overdrive only memory 2 in accordance with the write addresses 113 for (1) counting the address lines from the 80^{th} address line to the 120^{th} address line and then (2) counting the address lines from the 1^{st} address line to the 79^{th} address line, in the same way as the read addresses 112 of the next frame period T3. For this reason, the same image as that of the frame memory 1 in the next frame period T3 is stored in the overdrive only memory 2. Here, the image data from the 80^{th} address line to the 120^{th} address line of the frame memory 1 is stored in the 80^{th} address line to the 120^{th} address line of the overdrive only memory 2, and the image data from the 1^{st} address line to the 79^{th} address line of the frame memory 1 is stored in the 1^{st} address line to the 79^{th} address line of the overdrive only memory 2.

The simplified video image display including the overdrive processing is performed in the same way for subsequent frame periods as well.

In the liquid crystal display apparatus of the second embodiment, the read of the image data 102 from the overdrive only memory 2 in the current frame period is performed based on the read addresses 114 which are the same addresses as the read addresses 112 for the frame memory 1 in the previous frame period. Additionally, the image data in the frame memory 1 in the previous frame period is stored in the overdrive only memory 2. For this reason, the image data according to the image displayed on the liquid crystal panel 6 in the previous frame period, namely, the image data 101 read from the frame memory 1 in the previous frame period, can be used for the overdrive processing in the current frame period. As a result, it is possible to perform the overdrive processing by obtaining the difference between the image data of the current frame and the image data of the previous frame (corresponding to the image displayed on the liquid crystal panel 6), and prevent occurrence of a residual image due to the previous frame image.

In the liquid crystal display apparatus of the present invention, it is possible to read the image data 102 from the overdrive only memory 2 based on the read addresses 114 which are different from the read addresses 112 for the frame memory 1, since the overdrive only memory address control section 9 is provided to separately control accesses to the frame memory 1 and the overdrive only memory 2. Consequently, the image data 101 read from the frame memory 1 in the previous frame period, can be used for the overdrive processing in the current frame period as the image data 102. Therefore, the difference between the image data of the current frame and the image data of the previous frame (the display image of the liquid crystal panel) can be obtained, and the overdrive processing is correctly performed. That is to say, the present invention makes it possible to perform the correction in accordance with the difference from the previous frame image (the display image of the liquid crystal panel) for image data in the current frame, and provide the image with quality as high as the usual video image display, in which a residual image from the previous frame is not caused on a liquid crystal panel.

Although the embodiments of the present invention are described in detail above, concrete organization is not limited to the above embodiments and changes without departing from the scope of the present invention are included in the present invention. Though description is given on a display apparatus using a liquid crystal panel in the embodiments, the present invention is also applicable to display panels according to other techniques.

What is claimed is:

1. A display apparatus comprising:
a display panel;
a frame memory configured to store an image data;
an overdrive control section configured to perform overdrive processing on a first image data read from said frame memory in a current frame period, by using a second image data read from said frame memory in a previous frame period to generate overdrive-processed data; and
a display panel drive control section configured to drive said display panel based on the overdrive-processed data.

2. The display apparatus according to claim 1, further comprising:
an overdrive only storage unit,
wherein said display panel drive control section writes said second image data in said overdrive only storage unit in the previous frame period by using as a write start address a first address corresponding to a head address of an image data used to drive said display panel, and reads said first image data from said frame memory by using as a read start address in the current frame period, a second address different from the read start address in the previous frame period, and
said overdrive control section reads said second image data from said overdrive only storage unit by using said first address as the read start address in the current frame period and performs the overdrive processing on said first image data.

3. The display apparatus according to claim 2, wherein said first address is a start address of said overdrive only storage unit.

4. The display apparatus according to claim 2, wherein said first address is an address corresponding to the read start address in the previous frame period.

5. The display apparatus according to claim 1, wherein said overdrive control section adds a correction value determined based on a comparison result of said first image data and said second image data, to said first image data to generate a display image data to drive said display panel.

6. An image display method comprising:
storing an image data in a frame memory;
reading a first image data from said frame memory in a current frame period;
performing overdrive processing on said first image data, by using a second image data read from said frame memory in a previous frame period to generate overdrive-processed data; and
driving a display panel based on the overdrive-processed image data.

7. The image display method according to claim 6, further comprising:
writing said second image data in an overdrive only storage unit in a previous frame period by using as a write start address a first address corresponding to a head address of an image data used to drive said display panel,
wherein said reading said first image data comprises:
reading said first image data from said frame memory by using as the read start address in the current frame period, a second address different from the read start address in the previous frame period, and
wherein said performing overdrive processing comprises:
reading said second image data from said overdrive only storage unit by using said first address as the read start address in the current frame period.

8. The image display method according to claim 7, wherein said first address is a start address of said overdrive only storage unit.

9. The image display method according to claim 7, wherein said first address is an address corresponding to the read start address in the previous frame period.

10. The image display method according to claim 6, wherein said performing overdrive processing comprises:
adding a correction value determined based on a comparison result of said first image data and said second image data to said first image data to generate a display image data to drive said display panel.
